(19) United States
(12) Patent Application Publication
(10) Pub. No.: US 2010/0210982 A1
(43) Pub. Date: Aug. 19, 2010

(54) Method And System For Providing Segmental Gradient Compression

(76) Inventors: Niran Balachandran, Lewisville, TX (US); Tony Quisenberry, Highland Village, TX (US); Sam K. McSpadden, Austin, TX (US); Bob Blackwell, Colleyville, TX (US)

Correspondence Address: WINSTEAD PC, P.O. BOX 50784, DALLAS, TX, 75201, US

(21) Appl. No.: 12/708,422

(22) Filed: Feb. 18, 2010

Related U.S. Application Data
(63) Continuation-in-part of application No. 11/733,709, filed on Apr. 10, 2007.
(60) Provisional application No. 60/791,132, filed on Apr. 11, 2006.
(60) Provisional application No. 60/817,932, filed on Jun. 30, 2006.
(60) Provisional application No. 61/153,607, filed on Feb. 18, 2009.

(51) Int. Cl. A61H 7/00

(52) U.S. Cl. 601/152

(57) ABSTRACT

A system for providing segmental gradient compression to a body of a patient of the type comprising a wrap applied to an appendage of the patient. The system includes a control unit, a compression bladder, a barrier disposed within the compression bladder and defining a passive port, and first and second chambers disposed within the compression bladder. The first and second chambers are defined by the barrier and are fluidly coupled to each other via the passive port. This arrangement defines a flow path of a gas from the first chamber to the second chamber through the passive port. Inflation of the compression bladder with the gas results in sequential inflation of each chamber of the plurality of chambers thereby applying gradient circumferential pressure to the appendage of the patient.

### CROSS-REFERENCE TO RELATED APPLICATIONS

This application is a continuation-in-part of, and incorporates by reference the entire disclosure of, U.S. patent application Ser. No. 11/733,709, filed Apr. 10, 2007, titled Method and System for Thermal and Compression Therapy Relative to The Prevention of Deep Vein Thrombosis, which claims the benefit of U.S. Provisional Patent Application No. 60/791,132, filed Apr. 11, 2006 and U.S. Provisional Patent Application No. 60/817,932, filed Jun. 30, 2006. This application claims the benefit of, and incorporates by reference the entire disclosure of, U.S. Provisional Patent Application No. 61/153,607, filed Feb. 18, 2009. This application incorporates by reference the entire disclosure of U.S. patent application Ser. No. 10/894,369, filed Jul. 19, 2004, titled Compression Sequenced Thermal Therapy System.

### BACKGROUND

1. Technical Field

The present invention relates to medical-therapy systems in general, including therapeutic cooling, heating, and compression systems used in association therewith, and more particularly, but not by way of limitation, to an external-pneumatic compression system and method for providing segmental gradient compression.

2. Description of the Related Art

Medical-care providers have long recognized the need to provide warmth and cooling directly to patients as part of their treatment and therapy. Better recoveries have been reported using cold therapy for orthopedic patients. It is also desirable to cool portions of a patient's anatomy in certain circumstances. Yet another advantageous therapy is the application of heat then cold to certain areas of injury.

Several devices have been developed that deliver temperature-controlled fluids through, for example, pads or convective thermal wraps to achieve the thermal purpose described above. Typically these devices have a heating or a cooling element, a source for a fluid, a pump for forcing the fluid through a pad or thermal wrap, and a thermal interface between the patient and the temperature-controlled fluid. For example, mattress-cover devices containing liquid-flow channels have been used to provide selective heating or cooling by conduction.

Temperature-controlled fluid-circulating systems for automatically cooling a temperature-controlled fluid in a thermal wrap with a thermoelectric-cooling device having a cold side and a hot side when powered by electricity have been proposed. The temperature-controlled fluid is cooled by a cold side of the cooling device and is pumped through, to, and from the thermal wrap through a series of conduits.

### BRIEF SUMMARY

The present invention relates generally to a compression wrap for use with heating or cooling therapy. More particularly, and in various embodiments, the wrap includes a compression bladder having a gas input coupled to a control unit. In some embodiments, the compression bladder may have a top side and a bottom side, where the top side and the bottom side are connected at various points to create an gas flow channel.

In an embodiment, the above-described temperature therapy wrap further comprises an compression bladder disposed outwardly of the heat-transfer fluid bladder in an overlapping relationship therewith for providing select compression therapy, the compression bladder having an upper layer and a lower layer and an inlet port for providing gas from the control unit to the compression bladder.

In some embodiments, the wrap may be a trapezoidal wrap of the type that may be secured around an appendage of a patient. In some embodiments, the wrap may be formed of two sheets of biocompatible material, including the front and back of the wrap. The front and back are sealed or sewn together along a periphery of the wrap. Additionally, the wrap may be divided into a plurality of segmented chambers by welding the two layers together to form a barrier therebetween. A weld may extend from one side of the bladder almost entirely across the bladder. A void may be left in the barrier between the weld and the opposite side of the bladder. An additional weld may extend from the second side of the bladder almost entirely across the bladder. A void may be left between the weld and the opposite side of the bladder. The two welds may be made in such a way as to create an ‘S’ shaped channel. The three-segmented channel may allow the formation of a compression gradient across the three segments. In various embodiments, the welding may be accomplished by radio frequency (RF) welding. The wrap may also include flaps for securing the wrap to a patient via, for example, hook and loop.

In one embodiment the wrap may include a channel for receiving a gas, such as, for example, air, to cause compressions, an inlet valve coupled to the channel for delivering gas to the channel to create a pressure gradient across the wrap. The void between the segments may be relatively small so that inflation of the second segment lags inflation of the first segment. In that way, a single input may be utilized to create a pressure gradient across the length of the wrap. In one embodiment, the pressure gradient may be a predetermined pattern of sequentially inflating a plurality of the plurality of chambers to produce series of compression movements peripherally toward the heart of a patient, while another embodiment may include inflating two of the plurality of gas/air chambers simultaneously.

In yet another aspect, the above described compression therapy wrap further comprises a heat-transfer fluid bladder for providing temperature therapy to a portion of a patient. The bladder includes a heat-transfer fluid inlet port for delivering heat-transfer fluid from the control unit to the heat-transfer fluid bladder and a fluid outlet port for delivering heat-transfer fluid from the heat-transfer fluid bladder to the control unit. The heat-transfer fluid bladder delivers thermal therapy to a patient in the form of heat or cold or alternating heat and cold.

In yet another aspect, one embodiment of the invention includes a temperature therapy wrap comprising, a heat-transfer fluid bladder for housing heat-transfer fluid, the heat-transfer fluid bladder having a top layer and a bottom layer, a plurality of connections for dispersing the heat-transfer fluid throughout the wrap, the plurality of connections connecting the top layer to the bottom layer of the heat-transfer fluid bladder, at least one partition for directing the flow of the heat-transfer fluid through the heat-transfer fluid bladder; and means for providing sequenced flows of alternating heat and cold in a high thermal contrast modality to a patient.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a perspective view of a thermal and compression control unit for thermal and compression therapy;

FIG. 2 is a cut-away, perspective view of the control unit of FIG. 1 illustrating various elements thereof;

FIG. 3 is a cut-away, perspective view of the control unit of FIG. 1 taken from the opposite side of that shown in FIG. 2;

FIG. 4 is a rearwardly-oriented, perspective view of the control unit of FIG. 1;

FIG. 5 is a perspective view of a control unit connected to an electronic component;

FIG. 6 is a perspective view of a control unit connected to a wrap;

FIG. 7 is a perspective view of a control unit connected to multiple wraps;

FIG. 8 is a perspective view of a control unit connected to multiple wraps;

FIG. 9 is a plan view of an embodiment of a thermal therapy wrap;

FIG. 10 is a cross-sectional view of the wrap of FIG. 9;

FIG. 11 is a plan view of a first side of a thermal therapy wrap;

FIG. 12 is a plan view of a second side of a thermal therapy wrap;

FIG. 13 is a perspective view of a thermal therapy wrap disposed relative to an appendage of a patient;

FIG. 14 is a perspective view of a thermal therapy wrap disposed relative to an appendage of a patient and connected to a control unit;

FIG. 15 is a plan view of a thermal therapy wrap;

FIG. 16 is a plan view of a first side of a butterfly wrap;

FIG. 17 is a plan view of a second side of a butterfly wrap;

FIG. 18 is a plan view of a first side of the butterfly wrap with a second side overlay;

FIG. 19 is a plan view of a first side of a trapezoidal wrap;

FIG. 20 is a plan view of a second side of the trapezoidal wrap;

FIG. 21 is a plan view of the first side of the trapezoidal wrap with the second side overlaid;

FIG. 22 is a plan view of a first side of a trapezoidal wrap;

FIG. 23 is a plan view of another embodiment of the first side of the trapezoidal wrap; and

FIG. 24 is a plan view of the second side of the trapezoidal wrap.

### DETAILED DESCRIPTION

As will be described in more detail below, a control unit is shown that is adapted to provide thermally-controlled fluid and compressed gas for multiple therapeutic modalities. The control unit for providing these selective features may be enclosed within a single-chassis design capable of providing the described modalities. This selective versatility provides financial and manufacturing incentives in that the simple design can selectively provide an industrial, medical, or electro-optic version that produces only thermally-controlled liquid, such as, for example, co-liquid for cooling industrial equipment, in a configuration adaptable for other applications. In one embodiment, the size of the reservoir has been reduced relative to a number of earlier models of thermoelectric cooler (“TEC”) systems such that only approximately 175 Watts may be needed compared to 205 Watts required by typical earlier systems. As such, the control unit may be configurable with TEC assemblies thereby maximizing efficiency. With regard to a medical modality, thermal therapy may be afforded to a patient to reduce swelling and edema.

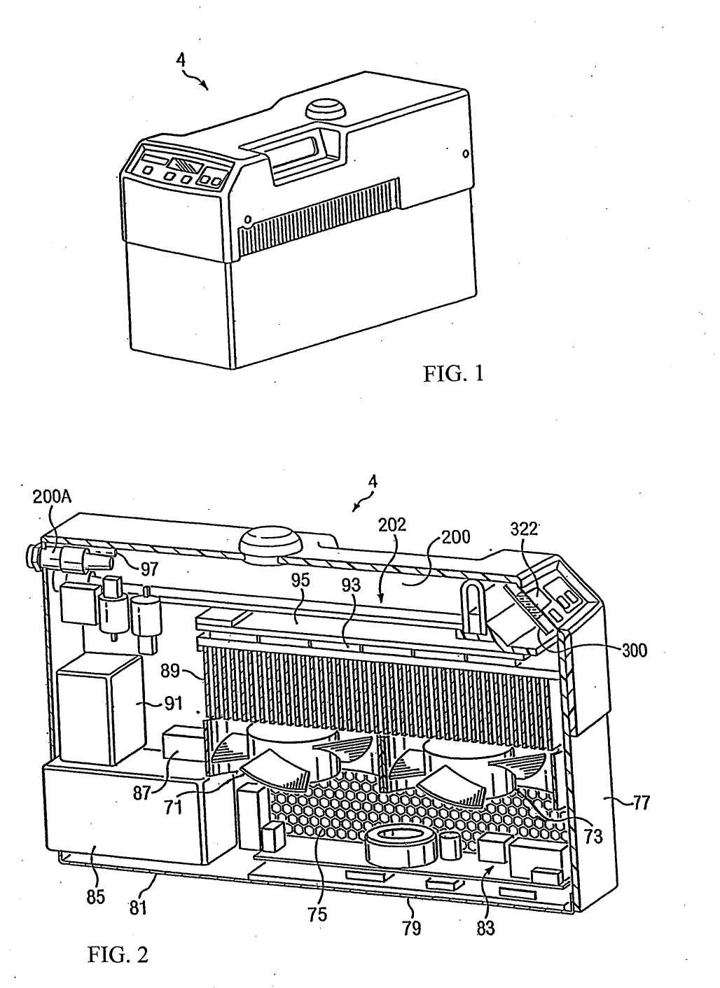

Referring now to FIG. 1, there is shown a thermal and compression-control unit 4 for thermal and compression therapy. The control unit 4 is operable to be coupled to, for example, thermal and compression elements to be applied to a patient as described below. In this particular view, the control unit 4 is shown in perspective to illustrate the assembly of one embodiment of a control unit for pumping gas and liquid through tubes to be described below for a patient to be treated therewith.

Referring now to FIG. 2, a lower portion of the control unit 4 of FIG. 1 includes a filter that may be removable from around a grate 75. In one embodiment, the filter includes a gas-filtering substance such as, for example, woven netting that may be attached by fasteners such as, for example, VELCRO® or the like. The filter may be attached outwardly of the grate 75 to allow for low-pressure drawing of a gas therethrough to allow cooling of components placed inwardly therein prior to upward drawing of the gas through fans disposed thereabove and forcing of the gas across a heat-transfer assembly (HTA) 202. The heat-transfer assembly (“HTA”) 202 is shown disposed beneath a fluid reservoir 200. The fluid reservoir 200 is adapted for storage of a liquid that may be pumped outwardly through a fluid connector 200A disposed rearwardly of the fluid reservoir 200. The fluid connector 200A is operable to be coupled to one or more pads or wraps via connector tubes as described below.

Still referring to FIG. 2, there is shown an embodiment of an internal portion of the control unit 4. Within the assembly of the control unit 4, fans 71 and 73 are shown disposed above a grate 75. The grate 75 contains therearound the filter portion that may be secured thereto by a hook and loop fastener such as, for example, VELCRO®. A lower portion of the grate 75 may be connected to a bottom portion 79 of a chassis 81 in a manner to provide support for electronic components 83 mounted thereon within the control unit 4. In some embodiments, a dual-fan arrangement may be utilized. As shown, the fans 71 and 73 may be positioned to push and/or pull gas from the grate 75 disposed peripherally about the electronic components 83 so that the gas flow is both quiet and at a rate allowing initial electronic cooling. The gas flow then being available to be pushed into the top section of the control unit 4 where most heat dissipation is needed.

Referring still to FIG. 2, in a typical embodiment, a power supply 85 is disposed adjacent to the bottom portion 79 of the chassis 81 and beneath a gas switch 87. The gas switch 87 is disposed beneath a heat sink 89 and adjacent to a fluid pump 91. In a typical embodiment, the power supply 85 may be a 500 Watt power supply; however, any appropriate size may be used. In some embodiments, additional power supplies may also be utilized to power various components. For example, in addition to a 500 Watt power supply, a 65 Watt power supply may be utilized for components requiring less power. In some embodiments, the power supply 85 is adapted to receive a plurality of inputs so the control unit 4 may be utilized in a plurality of countries without requiring substantial reconfiguration. In some embodiments, the power supply 85 may be adapted to be powered by a battery.

Still referring to FIG. 2, the fluid pump 91 is shown disposed in a position for collecting fluid from the fluid reservoir 200. The fluid reservoir 200 is thermally controlled by the HTA 202 for passage through the fluid connector 200A. Thermo-electric coolers (“TECs”) 93 are shown disposed between the heat sink 89 and a thermal-transfer plate 95 and provide requisite thermal control of a fluid within the fluid reservoir 200. A gas connector 97 is shown disposed adjacent to the fluid connector 200A and provides dissipation of gas for use in conjunction with, for example, a wrap to apply pressure via a bladder to force the fluid flowing from the fluid connector 200A to be in close contact with the patient as will be described below.

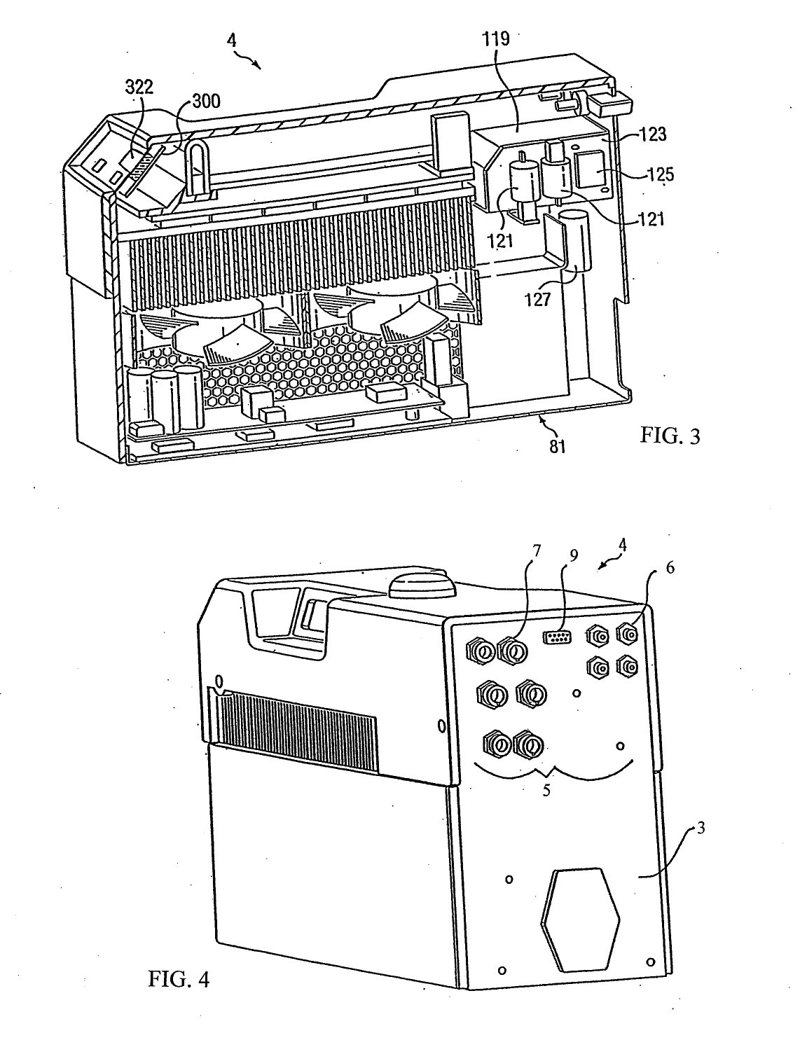

Referring now to FIG. 3, there is shown a cutaway perspective view of the control unit 4 taken from an opposite side thereof and illustrating various other aspects therein. In conjunction with the compression therapy operation, a gas pump 119 is shown disposed adjacent to a pair of solenoids 121. The pair of solenoids 121 are mounted on a gas bracket 123 adjacent a gas switch 125. A solenoid 127 is likewise disposed relative thereto; however, in various embodiments, more or less solenoids and/or gas switches may be disposed therein as needed.

Referring now to FIG. 4, there is shown a rearward-oriented perspective view of the control unit 4 illustrating connectors and couplings 5 on a rear panel 3 of the control unit 4. In FIG. 4, it may be seen that a plurality of fluid connectors 7 are utilized to provide thermally-conditioned heat-transfer fluid to a plurality of thermal-therapy devices. Additionally, a plurality of gas connectors 6 are utilized to provide pressurized gas to a plurality of compression-therapy devices. In some embodiments, the fluid connectors 7 are provided in pairs to facilitate circulation of heat-transfer fluid in a closed loop having an outward-bound and an inward-bound flow of the fluid to and from the fluid reservoir 200. In some embodiments, a single compression-therapy device may be coupled to the plurality of gas connectors 6 and the control unit 4 may be programmed accordingly to provide compressed gas to, for example, a plurality of wraps. Also shown in FIG. 4 is a connector 9 for data communication with the control unit 4. The connector 9 is shown by way of example in FIG. 4 to be an RS232 connector; however, other connections may be utilized such as, for example, a USB connection or a wireless connection.

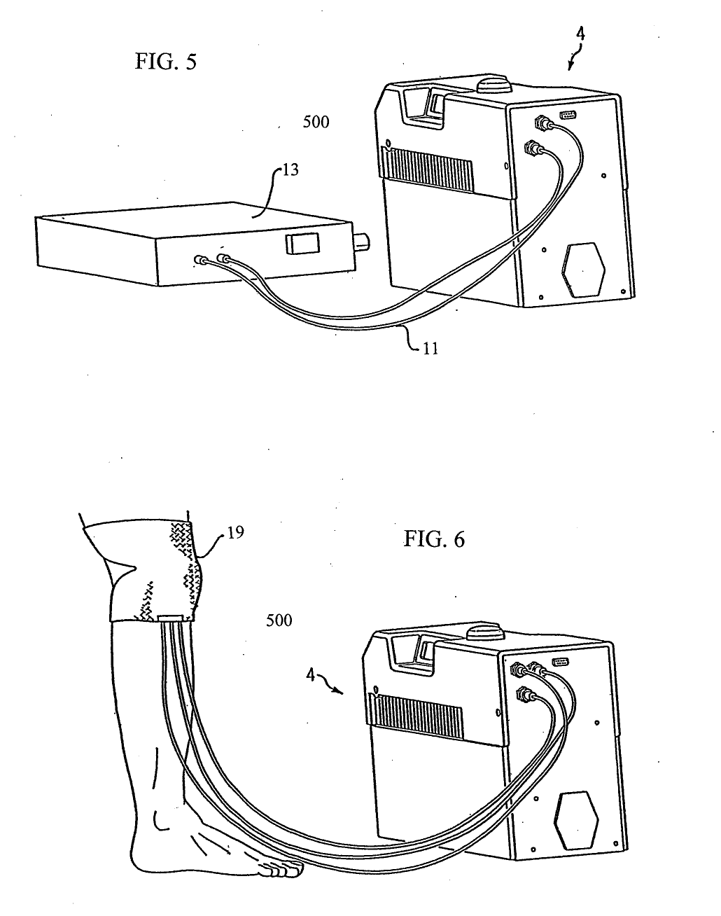

Referring now to FIGS. 5-8 collectively, various aspects of a plurality of embodiments of a compression and thermal therapy system 500 are shown. In FIG. 5, an industrial example is illustrated wherein a cooling umbilical 11 is provided connecting the control unit 4 to an article of electronic equipment 13. The cooling umbilical 11 may be utilized to cool the electronic equipment 13. Likewise in FIG. 6, the control unit 4 is shown to be connected to a therapy device 19 with three tubes. In some embodiments, two of the tubes are operable to deliver and return a heat-transfer fluid to and from the control unit 4 and the third tube is operable to deliver compressed gas for compression of the therapy device 19. The embodiment shown in FIG. 6 is a wrap for use around, for example, a patient's knee; however, similar wraps may also be used around any body part of the patient needing compression and/or thermal therapy, such as, for example, feet, calves, ankles, arms, or other areas.

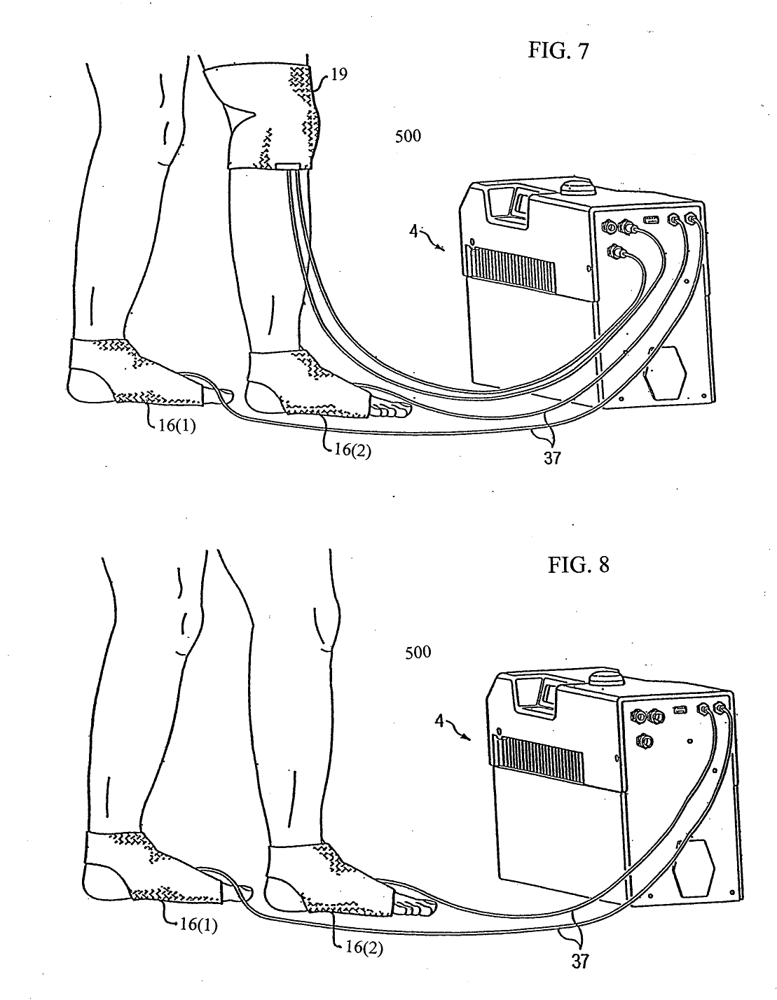

Referring now to FIG. 7, the control unit 4 is shown connected to the compression/thermal therapy device 19 and two Deep Vein Thrombosis (“DVT”) compression devices 16(1) and 16(2). By way of example, DVT compression is being provided, in FIG. 7, to a patient's right and left feet. Often times, pulses of compressed gas are alternated between the DVT compression devices 16(1) and 16(2) on the right and left feet. At the same time, as can be seen, thermal and/or compression therapy may be provided to, for example, a knee of a patient. When a pulse of compressed gas is provided to the DVT compression device 16(2) disposed on the same extremity as the thermal/compression therapy device 19, it is often desirable to deflate the thermal/compression therapy device 19 so that the thermal/compression therapy device 19 will not impede any fluidic movement caused by the DVT compression device 16(2). In FIG. 8, only DVT compression is being utilized via the DVT compression devices 16(1) and 16(2) from the control unit 4 as no thermal therapy umbilicals are therein utilized. As shown by way of example in FIGS. 7 and 8, the feet/ankle areas are covered; however, other body parts may be covered, such as, for example, calves, knees, arms, or other areas for purposes of applying pressure thereagainst

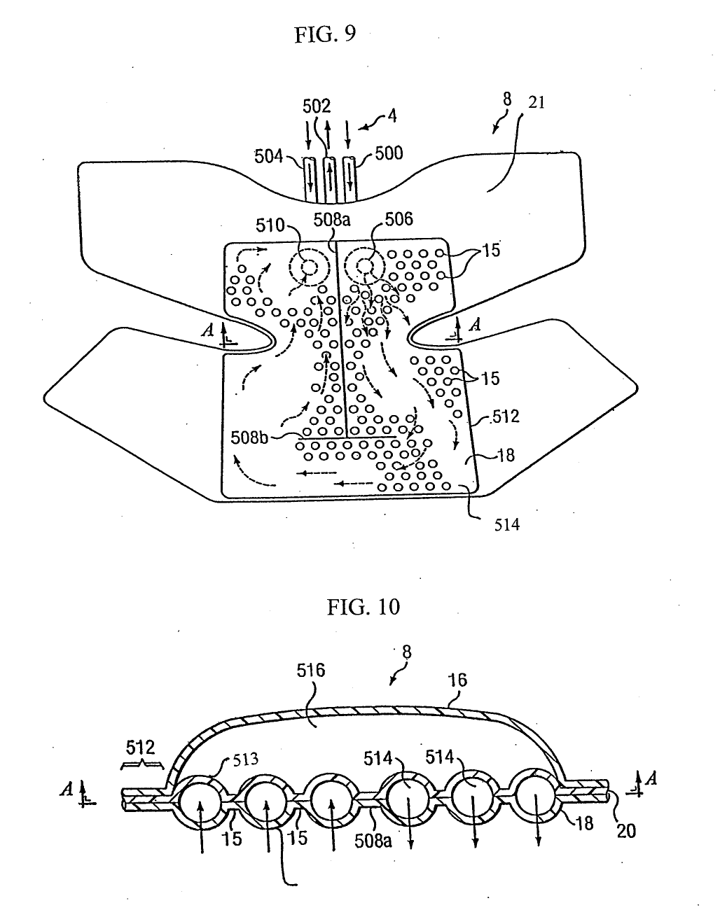

Referring now to FIG. 9, a temperature-therapy wrap 8 having a pre-selected shape and compression capabilities is illustrated. An underside 21 of the wrap 8, is placed directly against a portion of a patient. A heat-transfer fluid bladder 514 is thus adjacent to the patient. Heat-transfer fluid flows into the wrap 8 via an inlet hose 500 and heat-transfer fluid flows out of the wrap via an outlet hose 502. A gas for compression flows into the wrap 8 via a gas inlet hose 504. Heat-transfer fluid travels through the inlet hose 500, through a fluid inlet port 506, and into the wrap 8. Connections 15 connecting an upper layer 513 and a lower layer 511 (shown in FIG. 10) may be used to force the heat-transfer fluid to more evenly disperse throughout the heat-transfer fluid bladder 514. The partitions 508a, 508b control the flow of heat-transfer fluid throughout the heat-transfer fluid bladder 514. The partition 508a prevents heat-transfer fluid from entering the wrap 8 at the fluid inlet port 506 and immediately exiting the wrap 8 via the outlet port 510. The partition 508a forces the heat-transfer fluid to travel towards the end of the wrap 8 remote from the fluid inlet port 506. The partition 508b, in conjunction with the connections 15, causes the heat-transfer fluid to travel across the width of the wrap 8. The edges of the heat-transfer fluid bladder 514 are joined to the edges of the gas bladder 516 at seal 512. The heat-transfer fluid may then exit the wrap 8 at the outlet port 510. The travel of the heat-transfer fluid is indicated by arrows.

Referring now to FIG. 10, the wrap 8 is turned over relative to FIG. 9 and a cross-sectional view along line A-A of FIG. 9 is illustrated. As described above, the heat-transfer fluid bladder 514 (disposed against the patient) and the gas bladder 516 are joined together at the seal 512. The connections 15 join the upper layer 513 and the lower layer 511 of the heat-transfer fluid bladder 514 together. The partition 508a segregates the heat-transfer fluid near the fluid inlet port 506, illustrated by downward arrows, from the heat-transfer fluid flowing to the outlet port 510, illustrated by the upward arrows. The gas bladder 516 is oriented over the heat-transfer fluid bladder 514 and serves to press the heat-transfer fluid bladder 514 against a portion of the patient. In another embodiment, the heat-transfer fluid bladder 514 and the gas bladder 516 may have low-profile inline ports to afford increased comfort to a user by allowing the wrap 8 to lay substantially flat. Embodiments such as the embodiment shown may increase comfort and thereby allowing the patient to sleep or rest while using the wrap 8.

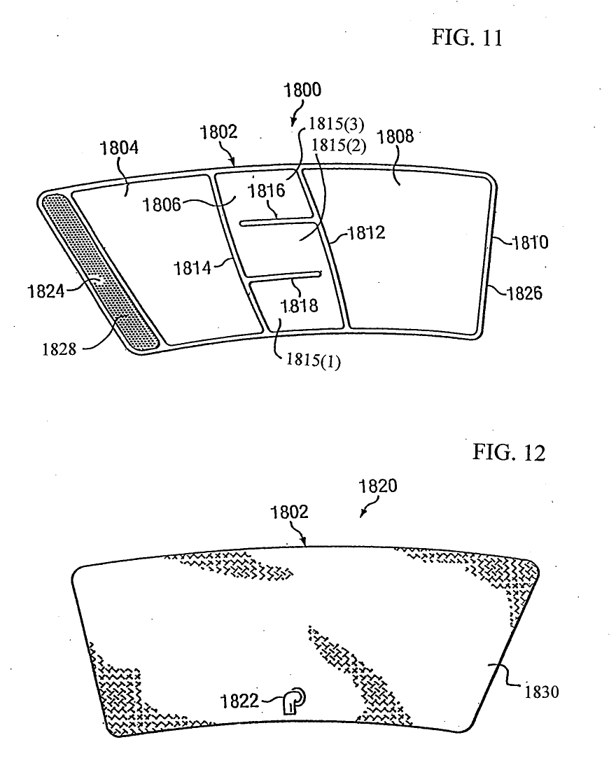

Referring now to FIG. 11, there is shown a trapezoidal calf wrap 1802 of the type that may be used for compression and/or thermal therapy. The calf wrap 1802 includes two sheets of biocompatible material that form a front 1800 and a back 1820 of the calf wrap 1802. The front 1800 and the back 1820 are sealed or sewn together at a sealed edge 1810. Additionally, the calf wrap 1802 is divided into three chambers (1804, 1806, and 1808) by welds 1812 and 1814. The middle chamber 1806 is characterized by two additional welds 1816 and 1818. The weld 1816 extends from the weld 1812 and the weld 1818 extends from the weld 1814, creating an ‘S’ shaped chamber having segments 1815(1), 1815(2), and 1815(3). In one embodiment, the segments 1815(1), 1815(2), and 1815(3) have widths between approximately 3.5 inches and approximately 4.5 inches. The three-chamber structure as described herein permits a compression gradient to be formed across the three chambers. In various embodiments, all welding may be accomplished by radio-frequency (RF) welding. The front 1800 also includes flaps 1824 and 1810. In various embodiments, the flap 1824 may have sealed or sewn thereon a hook fastener 1828 such as, for example, Velcro®. The back 1820 may include a corresponding pile fastener 1830 such as, for example, Velcro® compatible to receive the hook fastener 1828. As can be seen in FIG. 12, an inlet 1822 is located on the back 1820 of the calf wrap 1802 to facilitate intake and exhaust of gas. In various embodiments, and as will be described in more detail below, additional inputs may be included such as, for example, a heat-transfer input and output.

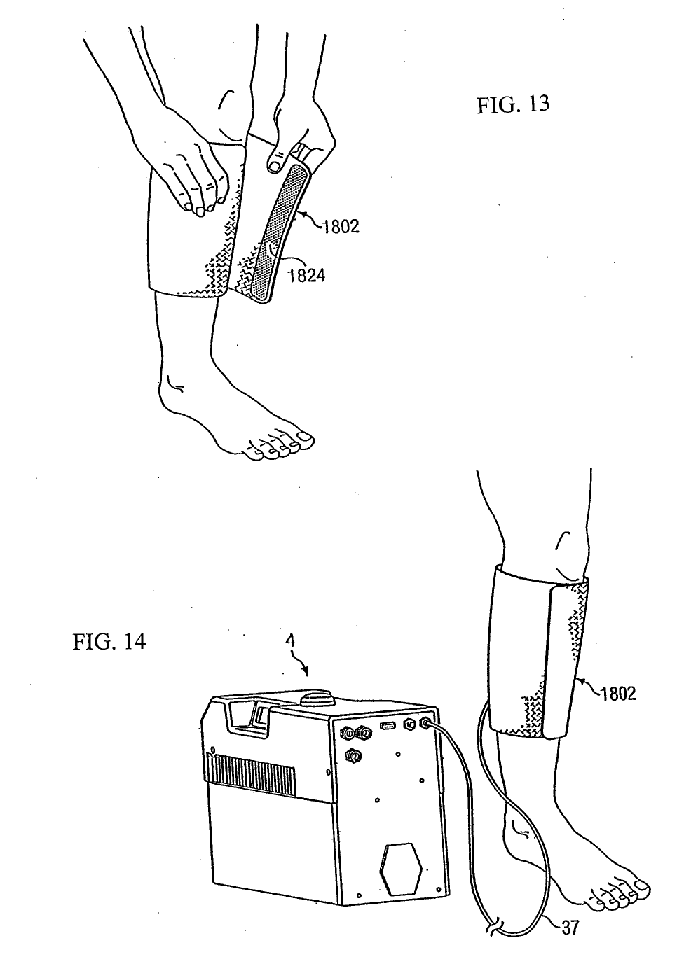

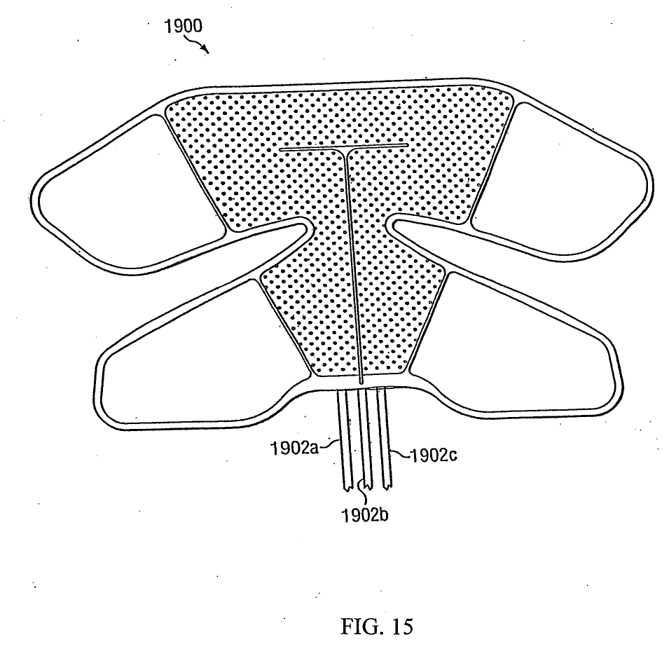

Referring now to FIGS. 13 and 14, in operation, the calf wrap 1802 is positioned on a front side of the calf. The flap 1826 is pulled tight and then the flap 1824 is pulled tight overtop of the flap 1826 and attached thereto. With reference to FIG. 14, the calf wrap 1802 may be connected to the control unit 4 by connecting connector 37 to inlet 1822. Alternatively, the calf wrap 1802 may be coupled to a control unit 4 that is portable. While the embodiment described above pumps gas to provide compression, it is also contemplated that other substances could be utilized to provide the desired compression. Similarly, other shapes and sizes of wraps may be utilized. Referring now to FIG. 15, a wrap 1900 having three connectors 1902a-1902c are shown. A circuitous path can be seen where various welds have been made to force a heat-transfer fluid to disperse throughout the wrap.

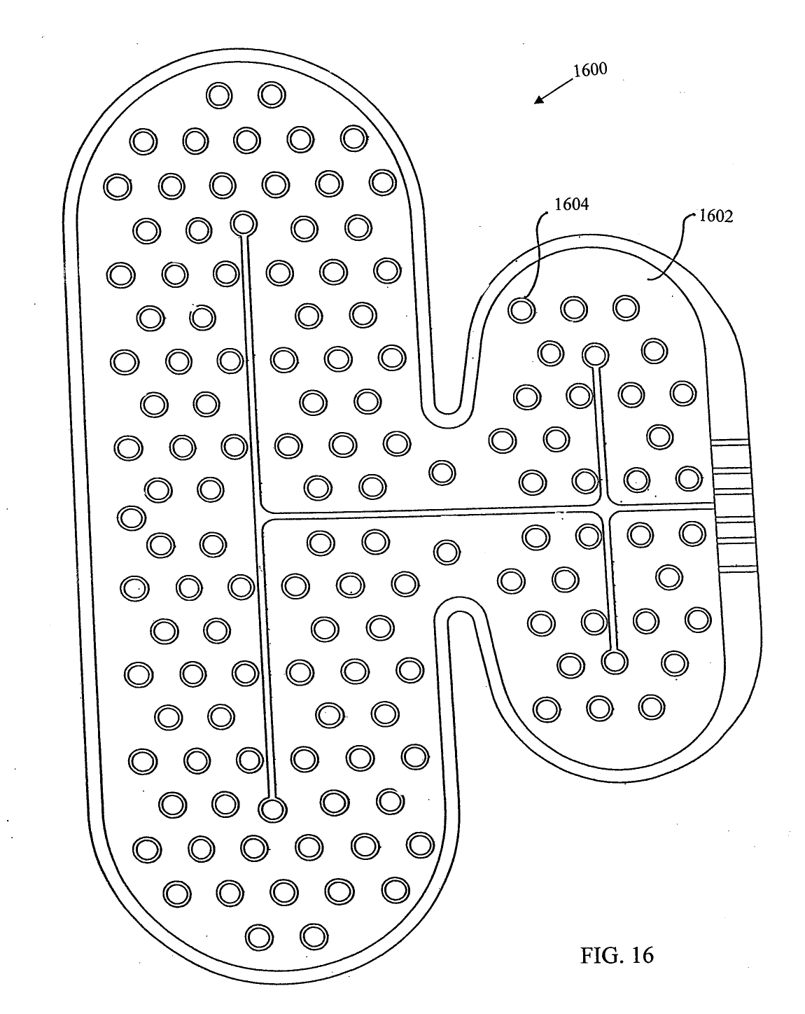

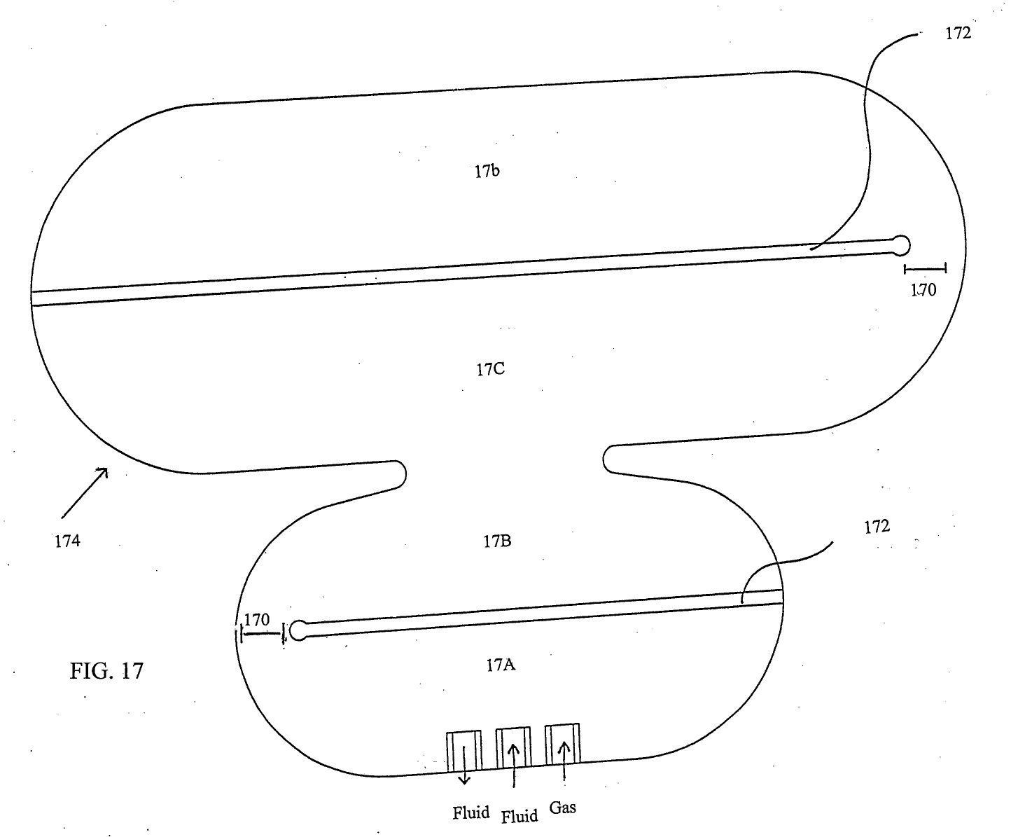

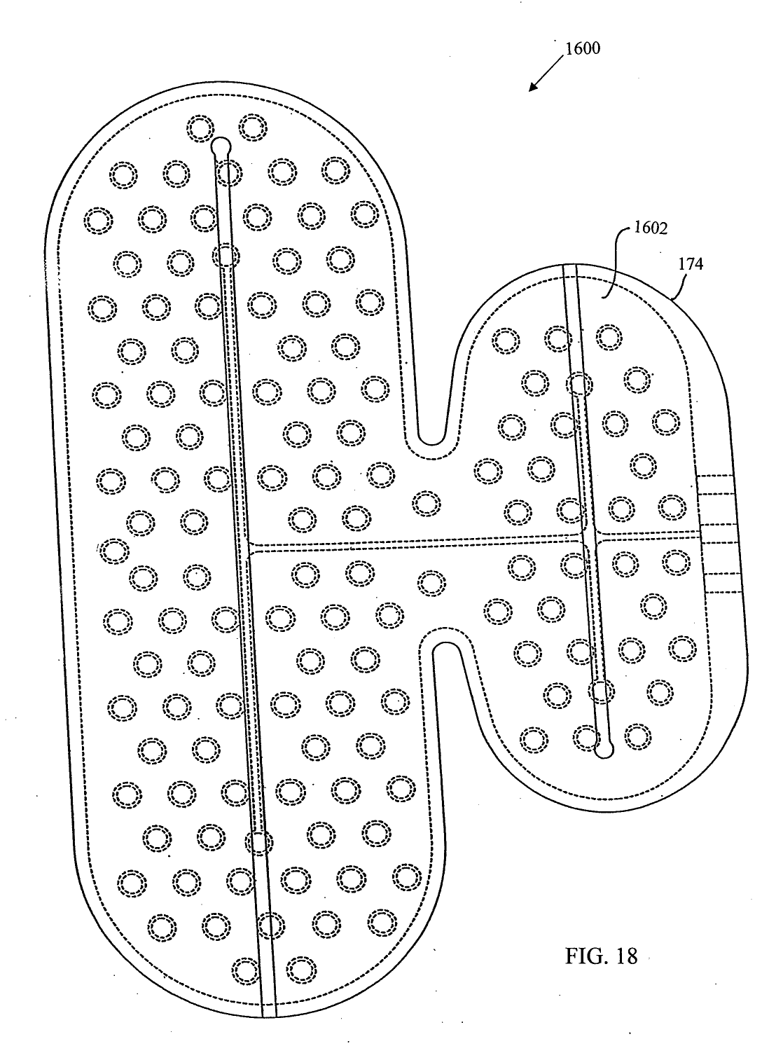

Referring now to FIGS. 16-18, various views of a butterfly-shaped embodiment of a wrap 1600 can be seen. Referring specifically to FIG. 16, a heat-transfer fluid bladder 1602 on an inside of the wrap adapted to be disposed against a skin of a patient is shown. In the embodiment shown, additional welds have been disposed within the wrap to create a desired heat-transfer flow path. A plurality of circles 1604 disposed throughout the wrap are adapted to secure a top surface to a bottom surface of the heat-transfer fluid bladder at a plurality of locations. In this way, the heat-transfer fluid will more evenly disperse throughout the heat-transfer fluid bladder. Referring now to FIG. 17, a compression bladder 174 on an opposite side of the wrap 1600 is operable to be disposed outwardly from the heat-transfer fluid bladder relative to a patient. In the embodiment shown, a single gas-input line may be utilized to provide compressed gas to inflate the compression bladder 174. A plurality of welds 172 may be disposed within the compression bladder to form barriers between a plurality of chambers 17A, 17B, 17C, and 17D within the compression bladder 174. In an embodiment, the plurality of chambers 17A, 17B, 17C, and 17D may have a width ranging from less than approximately 2.5 inches to more than approximately 3.5 inches. The welds 172 may extend from one edge of the wrap 1600 laterally substantially across the wrap 1600, creating voids 170 between each of the chambers and thereby creating a serpentine gas flow path through the compression bladder 174. In one embodiment, the welds 172 may have a thickness ranging from less than approximately 0.125 inches to more than approximately 0.25 inches. Depending on the desired delay to the rate of inflation of the chambers, the voids 170 may have widths ranging from less than approximately 0.9 inches to more than approximately 1.25 inches. During inflation, the chamber closest to the gas input will inflate first. In the embodiment shown, the first chamber 17A inflates first providing compression to an area of a patient disposed relative to the first chamber 17A. The void 170 between chamber 17A and chamber 17B allows gas to pass therethrough while the first chamber 17A is inflating and thereby causing chamber 17B to inflate subsequent to inflation of the chamber 17A. In a similar manner, chamber 17C will inflate followed by chamber 17D creating a segmental pressure gradient from 17A to 17D. In this sense, the void 170 defines a passive port that regulates the flow of gas between the chambers 17A-17D but requires to electrical or mechanical actuation. Once the last chamber has fully inflated, the control unit 4 (not explicitly shown in FIG. 17) may then begin deflating the compression bladder 174. Referring now to FIG. 18, the heat-transfer fluid bladder 1602 has been overlaid on top of the compression bladder 174 to show how inflation of the compression bladder 174 can be utilized to compress the heat-transfer fluid bladder 1602 against the patient and thus increase the rate of heat transfer to the patient.

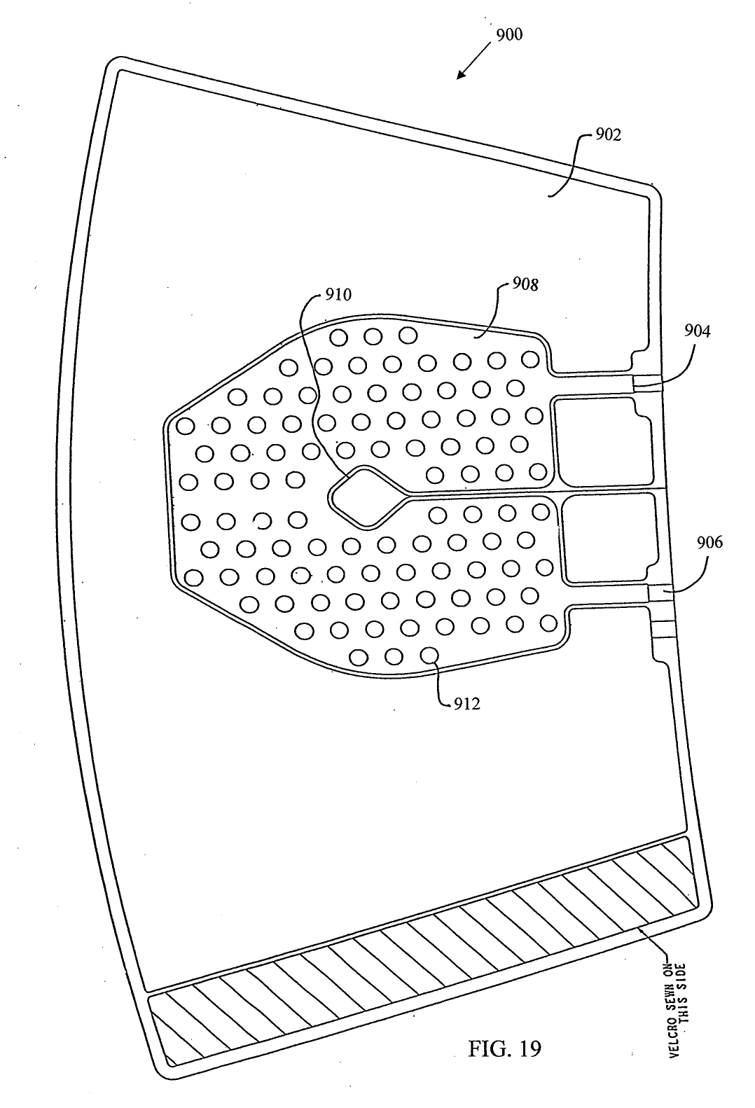

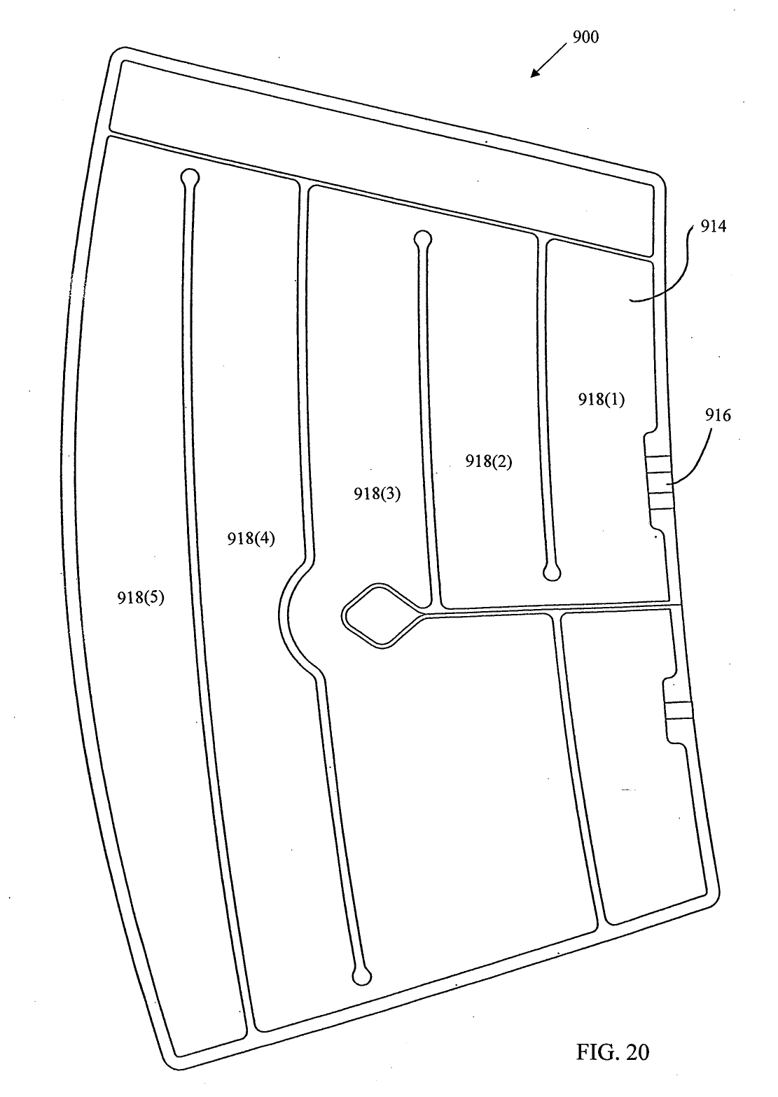

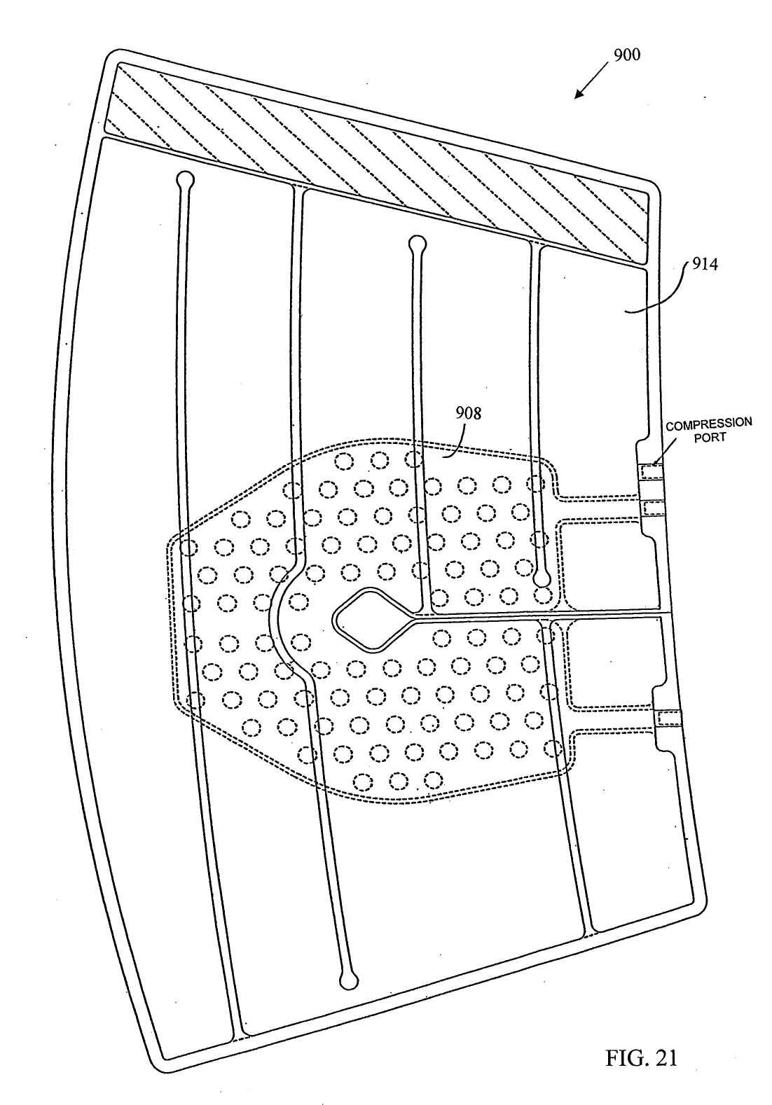

Referring now to FIG. 19, a heat-transfer fluid bladder 908 of a trapezoidal wrap 900 is shown. In FIG. 19, the heat-transfer fluid bladder 908 is shown by way of example to be smaller than the entire size of the trapezoidal wrap 900. However, the heat-transfer fluid bladder 908 may be any appropriate size including substantially the same size as the trapezoidal wrap 900. Similar to FIG. 16, a circuitous heat-transfer fluid flow path created by a long weld 910 and a plurality of circular welds 912. In this embodiment, the heat-transfer fluid enters at an input port 904 and is forced to travel around the long weld 910 before exiting via an output port 906. Referring now to FIG. 20, a compression bladder 914 of the trapezoidal wrap 900 can be seen. In this embodiment, compressed gas enters through an gas input 916 and causes a first chamber 918(1) to inflate. A second chamber 918(2) then inflates, followed by a third chamber 918(3), then a forth chamber 918(4), and finally a fifth and last chamber 918(5) inflates. In this way, a segmental pressure gradient can be created along the length of the trapezoidal wrap 900, such as, for example, from a distal end of a patient's leg proximally towards a patient's heart. By way of example, the trapezoidal wrap 900 is depicted in FIG. 19 as having five chambers 918(1)-918(5); however, any number of chambers may be used. Referring now to FIG. 21, the heat-transfer fluid bladder 908 has been overlaid onto the compression bladder 914 of the trapezoidal wrap 900 to show how gradient pressure can be provided in conjunction with thermal therapy.

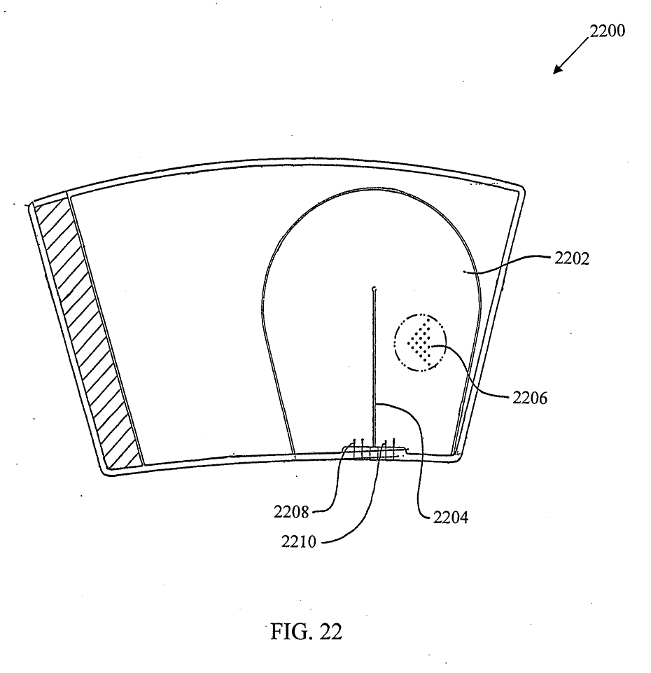

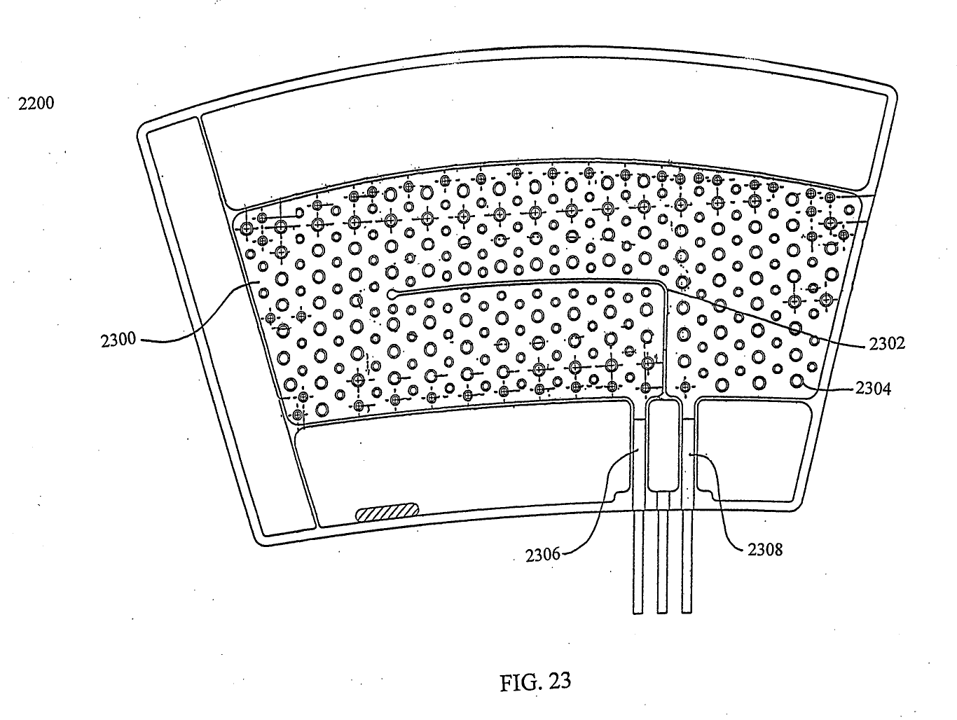

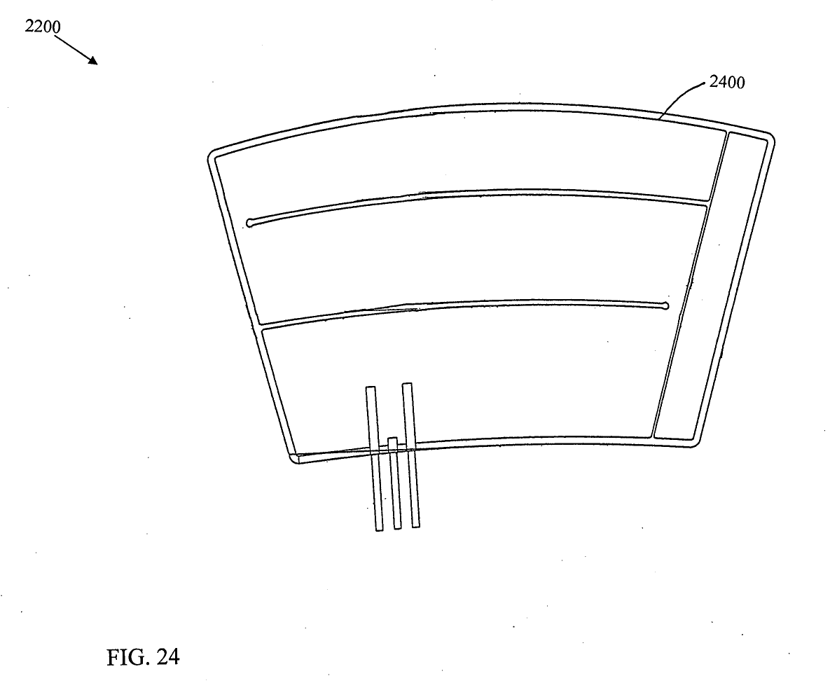

Referring now to FIG. 22, a heat-transfer fluid bladder 2202 of a trapezoidal wrap 2200 is shown. In FIG. 22, the heat-transfer fluid bladder 2202 is shown by way of example to be smaller than the entire size of the trapezoidal wrap 2200. However, the heat-transfer fluid bladder 2202 may be any appropriate size including substantially the same size as the trapezoidal wrap 2200. A circuitous heat-transfer fluid flow path created by a long weld 2204 and a plurality of circular welds 2206. In this embodiment, the heat-transfer fluid enters at an input port 2208 and is forced to travel around the long weld 2204 before exiting via an output port 2210. Referring now to FIG. 23, another embodiment of a heat-transfer fluid bladder of trapezoidal wrap 2200 is shown. Heat-transfer fluid bladder 2300 includes a circuitous heat-transfer fluid flow path created by a long weld 2302 and a plurality of circular welds 2304. Heat-transfer fluid enters at an inlet port 2306 and is forced to travel around the long weld 2302 before exiting via an outlet port 2308. Referring now to FIG. 24 a compression bladder 2400 of the trapezoidal wrap 2200 can be seen. In this embodiment, compressed gas enters through an gas input 2402 and causes a first chamber 2404(1) to inflate. The first chamber 2404(1) is in fluid communication with a second chamber 2404(2) by way of a port 2406(1). The second chamber 2404(2) is in fluid communication with a third chamber 2404(3) by way of a port 2406(2). Flow of gas through the ports 2406(1)-(2) is restricted thus causing inflation of the second chamber 2404(2) to lag inflation of the first chamber 2404(1). Similarly, inflation of the third chamber 2404(3) lags inflation of the second chamber 2404(2). Thus, as the first chamber 2404(1) inflates, the second chamber 2404(2) then inflates, followed by the third chamber 2404(3). In this way, a segmental pressure gradient can be created along the length of the trapezoidal wrap 2200, such as, for example, from a distal end of a patient's leg proximally towards a patient's heart. In one embodiment, the first, second, and third chambers 2404(1)-(3) have a width between approximately four inches and approximately seven inches. In one embodiment, the ports 2406(1)-(2) have a width of approximately one inch. By way of example, the trapezoidal wrap 200 is depicted in FIG. 24 as having three chambers 2404(1)-2404(3); however, any number of chambers may be used.

The previous description includes a description of various embodiments. The scope of the invention should not necessarily be limited by this description. The scope of the present invention is instead defined by the following claims.

What is claimed is:

1. A system for providing gradient compression to a body of a patient, the system comprising:
a control unit;
a therapeutic pad coupled to the control unit via at least one tube, the therapeutic pad having a distal end and a proximal end and adapted to be wrapped around an appendage of a patient;
a compression bladder disposed within the therapeutic pad;
a first barrier disposed within the compression bladder, the first barrier extending laterally from a first side of the compression bladder to define a top side of a first chamber of the compression bladder and a bottom side of a second chamber of the compression bladder, the first chamber and the second chamber being in flow communication via a first passive port;
a second barrier disposed within the compression bladder the second barrier extending laterally from a second side of the compression bladder to define a top side of the second chamber and a bottom side of a third chamber of the compression bladder, the second chamber and the third chamber being in flow communication via a second passive port; and
a port coupled to the first chamber of the compression bladder and adapted to receive compressed gas from the control unit and exhaust gas back to the control unit, such that during use a pressure gradient is produced across the barriers separating the chambers within the compression bladder thereby applying gradient circumferential pressure to the appendage of the patient.

2. The system of claim 1, wherein the control unit is adapted to provide compressed gas at a pressure of at least 25 mmHg greater than ambient atmospheric pressure for a predetermined amount of time.

3. The system of claim 1, wherein the first and second barriers are formed from first and second air-tight welds between an upper layer and a lower layer of the compression bladder.

4. The system of claim 1, wherein the first passive port is defined by the first barrier and a side of the compression bladder.

5. The system of claim 1, wherein the second passive port is defined by the second barrier and a side of the compression bladder.

6. The system of claim 1, wherein the first, second, and third chambers define a serpentine fluid flow path within the compression chamber.

7. The system of claim 1, wherein the pressure gradient is produced between the distal end of the therapeutic pad and the proximal end of the therapeutic pad.

8. The system of claim 1, wherein the first passive port restricts a flow of fluid from the first chamber to the second chamber thereby causing inflation of the second chamber to lag inflation of the first chamber.

9. The system of claim 1, wherein the second passive port restricts a flow of fluid from the second chamber to the third chamber thereby causing inflation of the third chamber to lag inflation of the second chamber.

10. The system of claim 1, further comprising a thermal bladder coupled to the compression bladder.

11. The system of claim 10, wherein the thermal bladder is configured to receive a heat transfer fluid from the control unit for providing thermal therapy to the appendage of the patient.

12. A method of providing gradient compression to a body of a patient, the method comprising:
providing a compression wrap having first, second, and third chambers disposed therein and separated by barriers therebetween, the first, second, and third chambers being in flow communication for a gas passing therethrough;
connecting the chambers of the compression wrap to a control unit via at least one tube;
wrapping the compression wrap about an appendage of the patient;
inflating, at a first inflation rate, the first chamber via introduction of a gas through an inlet port;
restricting, via a first passive port in a first barrier between the first and second chambers, a flow of gas from the first chamber to the second chamber;
inflating, at a second inflation rate, the second chamber via passive flow of the gas from the first chamber to the second chamber;
restricting, via a second passive port in a second barrier between the second and third chambers, a flow of gas from the second chamber to the third chamber;
inflating, at a third inflation rate, the third chamber via passive flow of the gas from the second chamber to the third chamber, thereby applying gradient circumferential compression to the appendage of the patient; and
exhausting the gas from the compression wrap through the inlet port to relieve the gradient circumferential pressure.

13. The method of claim 12, wherein the first rate of inflation is greater than the second rate of inflation and the second rate of inflation is greater than the third rate of inflation.

14. The method of claim 12, wherein the flow path comprises a serpentine shape.

15. The method of claim 12, wherein applying gradient circumferential compression comprises applying greater pressure to a distal end of the appendage than is applied to a proximal end of the appendage.

16. The method of claim 12, further comprising applying, via a heat-transfer fluid circulated through a thermal bladder, thermal therapy to the appendage.

17. The method of claim 16, wherein the thermal bladder is coupled to the compression bladder.

18. The method of claim 12, wherein the first and second passive ports require no electrical or mechanical actuation.

19. The method of claim 12, wherein a flow rate of the gas into the first chamber exceeds a flow rate of the gas into the second chamber.

20. A system for providing gradient compression to an appendage of a patient, the system comprising:
a control unit configured to provide a compressed gas;
a therapeutic pad having a compression bladder therein coupled to the control unit via an inlet port disposed at a distal portion of the compression bladder, the therapeutic pad having a distal end and a proximal end and configured to be wrapped around an appendage of a patient to provide circumferential pressure to the appendage when the control unit provides the compressed gas;
a first barrier within the compression bladder defining a top side of a first chamber of the compression bladder and a bottom side of a second chamber of the compression bladder, the first chamber being disposed at the distal portion of the compression bladder and in fluid communication with the second chamber via a first passive port, the second chamber being proximately disposed relative to the first chamber;
a second barrier within the compression bladder defining a top side of the second chamber of the compression bladder and a bottom side of a third chamber of the compression bladder, the second chamber being distally disposed relative to the third chamber and in fluid communication therewith via a second passive port;
wherein, in use, the compressed gas from the control unit passes through the inlet port to inflate the first chamber at a first rate of inflation, at least a portion of the compressed gas flows through the first passive port to inflate the second chamber at a second rate of inflation, and at least a portion of the compressed gas flows through the second passive port to inflate the third chamber at a third rate of inflation;
wherein the first and second passive ports restrict the flow of the compressed gas therethrough such that the first rate of inflation is greater than the second rate of inflation and the second rate of inflation is greater than the third rate of inflation, thereby creating a pressure gradient from the distal portion of the therapeutic pad to the proximal portion thereof; and
wherein, when the control unit ceases providing the compressed gas, the compressed gas inside the compression bladder exits through the inlet port.
